(19) United States
(12) Patent Application Publication
(10) Pub. No.: US 2008/0297963 A1
(43) Pub. Date: Dec. 4, 2008

(54) ADJUSTABLE OVER CURRENT PROTECTION CIRCUIT WITH LOW POWER LOSS

(76) Inventors: Hung-Ta Lee, Hsin-Chu (TW); Ming-Ying Kuo, Hsin-Chu (TW); Chun-Liang Lin, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/756,622

(22) Filed: May 31, 2007

(51) Int. Cl. H02H 3/08; G05F 1/573

(52) U.S. Cl. 361/87; 323/277

(57) ABSTRACT

Disclosed is an adjustable over current protection circuit which advances the timing of enabling an over current protection mechanism according to an input voltage, therefore the delay problem resulting from the non-instant response of the over current protection circuit is compensated with a low power loss. The over current protection circuit includes a voltage divider, a voltage-to-current converting circuit, an adjusting circuit and a comparing circuit. The voltage divider divides an input voltage to generate an adjusted input voltage, and the adjusted input voltage is converted into an adjusted input current by the voltage-to-current converting circuit. The adjusting circuit then adjusts a current sensing voltage according to the adjusted input current to generate an adjusted current sensing voltage. Finally, the comparing circuit compares the adjusted current sensing voltage with a predetermined over current protection reference voltage to selectively enable the over current protection mechanism according to a comparison result.

### BACKGROUND OF THE INVENTION

1. Field of the Invention

The invention relates to an over-current protection circuit, and more particularly, to an adjustable over-current protection circuit with low power consumption and a compensation mechanism thereof.

2. Description of the Prior Art

One of the most fundamental requirements in an electrical system is proper over-current protection. Usually, an over-current protection mechanism protects the circuit components by turning off some specific elements in the circuit when detecting that the current flowing through is greater than the maximum current affordable by the circuit. For example, a conventional over-current protection circuit implemented in a voltage converter may comprise a comparator utilized to compare a current sensing voltage generated by a current sensing resistor in the voltage converter with a predetermined over-current protection reference voltage. Ideally, if the current sensing voltage reaches the predetermined over-current protection reference voltage, the conventional over-current protection circuit will immediately shut down a power switching transistor coupled to the current sensing resistor, causing the current flowing through the transistor and the transformer of the voltage converter to immediately decrease to zero, preventing undesired damage to the voltage converter.

In practice, however, the over-current protection circuit cannot act instantly when it detects an over-current situation: there is a delay (0.1-0.3 μs) inherent in circuit from the time the over-current protection circuit is triggered to the time it outputs a control signal to turn off the power switching transistor. Moreover, the current sensing voltage increases with time and the increasing rate is proportional to the input DC voltage of the converter. That is, the higher the input DC voltage is, the faster the current sensing voltage increases, and therefore the more the current sensing voltage exceeds the predetermined over-current protection reference voltage when the power switching transistor is turned off by the over-current protection circuit. Therefore, when the input voltage is high, the real over current protection point at output is more high above predetermined value. Then the damage caused from the imprecise over-current protection mechanism becomes more severe.

Another reason resulting in the imprecise over-current protection mechanism is that the resistor-capacitor circuit, utilized to filter out the turn-on spike of the transistor in the voltage converter, delays the shutdown time of the transistor. Hence, it takes longer for the overage current to be stopped after the over-current protection circuit has detected the over-current situation, causing even greater possibility of damage to the voltage converter due to poor response time.

Please refer to FIG. 1, which illustrates a conventional solution to the above problems. As shown in FIG. 1, a resistance R₂ is added between the input node of the voltage converter 100 and the current sensing pin CS of the regulating IC 110. The voltage detected by the current sensing pin CS is equal to V_{indc}*(R₁+R_{S})/(R₁+R₂+R_{S}), where V_{indc} is the input DC voltage, R_{S} is the current sensing resistor, and R₁ incorporated with C₁ forms the resistor-capacitor circuit mentioned above. In this way, the current sensing voltage is compensated by a DC voltage offset proportional to the input DC voltage V_{indc}, and thereby the over-current protection circuit (embedded in the regulating IC 110 in this exemplary case) can enable the over-current protection mechanism in advance to make up for the delays due to both the resistor-capacitor circuit and the over-current protection circuit.

Although the addition of R₂ solves the problem it increases the power loss consumed by the voltage converter 100. Therefore, the voltage converter 100 may not conform to power saving requirements. To reduce power consumption, the resistance values of R₁ and R₂ must be increased. Increasing the resistance R₁, however, will make the resistive-capacitive (RC) time constant larger and worsen the delay resulting from the resistor-capacitor circuit mentioned above. In addition, increasing the resistance R₂ will increase the noise of the circuit, influencing the detection of the regulating IC 110. That is, the power loss problem existing in the conventional voltage converter 100 cannot be properly overcome.

### SUMMARY OF THE INVENTION

Therefore, one objective of the present invention is to provide an adjustable over-current protection circuit able to compensate for the above-mentioned delay problems while exhibiting low power consumption.

According to an exemplary embodiment of the present invention, an adjustable over-current protection circuit is disclosed. The adjustable over-current protection circuit comprises a voltage divider, a voltage-to-current converting circuit, an adjusting circuit, and a comparing circuit. The voltage divider is for dividing an input voltage to generate an adjusted input voltage. The voltage-to-current converting circuit is coupled to the voltage divider, and is for converting the adjusted input voltage into an adjusted input current. The adjusting circuit is coupled to the voltage-to-current converting circuit, and is for adjusting a current sensing voltage generated by a current flowing through a current sensing resistor according to the adjusted input current to generate an adjusted current sensing voltage. The comparing circuit is coupled to the adjusting circuit, and is for comparing the adjusted current sensing voltage with a predetermined over-current protection reference voltage to selectively enable an over-current protection mechanism according to the comparison result.

According to another exemplary embodiment of the present invention, an adjustable over-current protection circuit is disclosed. The adjustable over-current protection circuit comprises a voltage divider, a first voltage-to-current converting circuit, a second voltage-to-current converting circuit, an adjusting circuit, a current-to-voltage converting circuit, and a comparing circuit. The voltage divider is for dividing an input voltage to generate an adjusted input voltage. The first voltage-to-current converting circuit is coupled to the voltage divider, and is for converting the adjusted input voltage into an adjusted input current. The second voltage-to-current converting circuit is for converting a predetermined over-current protection reference voltage into an over-current protection reference current. The adjusting circuit is coupled to the first and second voltage-to-current converting circuits, and is for adjusting the over-current protection reference current according to the adjusted input current to generate an adjusted over-current protection reference current. The current-to-voltage converting circuit is coupled to the adjusting circuit, and is for converting the adjusted over-current protection reference current into an adjusted over-current protection reference voltage. The comparing circuit is coupled to the current-to-voltage converting circuit, and is for comparing the adjusted over-current protection reference voltage with a current sensing voltage generated by a current flowing through a current sensing resistor to selectively enable an over-current protection mechanism according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional over-current protection circuit implemented in a voltage converter.

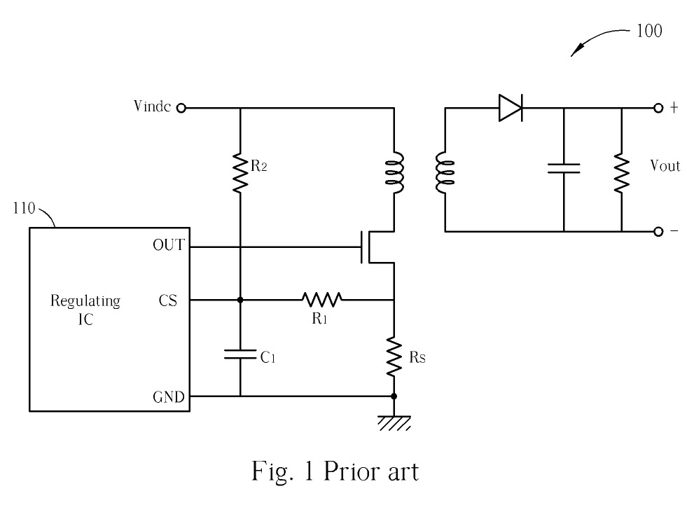

FIG. 2 is a diagram of an adjustable over-current protection circuit according to an exemplary embodiment of the present invention.

FIG. 3 is a diagram showing how the over-current protection circuit of FIG. 2 is implemented in a voltage converter according to an exemplary embodiment of the present invention.

FIG. 4 shows an exemplary embodiment of the adjusting circuit of FIG. 3.

FIG. 5 is a diagram of an adjustable over-current protection circuit according to another exemplary embodiment of the present invention.

FIG. 6 is a diagram showing how the over-current protection circuit of FIG. 5 is implemented in a voltage converter according to an exemplary embodiment of the present invention.

FIG. 7 shows an exemplary embodiment of the adjusting circuit of FIG. 5.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

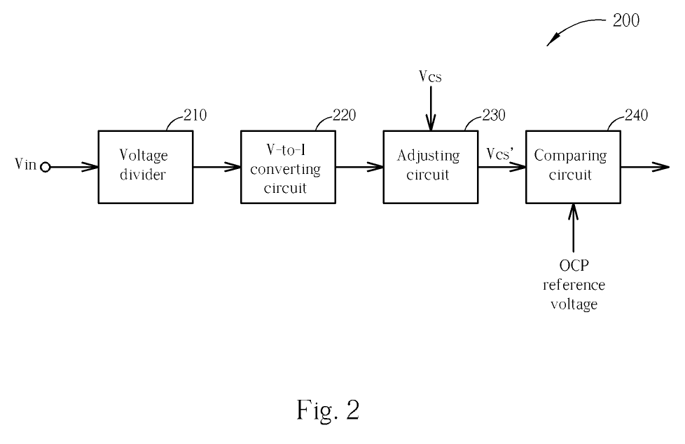

Please refer to FIG. 2, which is a diagram of an over-current protection circuit according to an exemplary embodiment of the present invention. The over-current protection circuit 200 comprises a voltage divider 210, a voltage-to-current converting circuit 220, an adjusting circuit 230, and a comparing circuit 240. The voltage divider 210 first divides an input voltage Vᵢₙ to generate an adjusted input voltage. The voltage-to-current converting circuit 220 then converts the incoming adjusted input voltage into an adjusted input current, which is utilized by the following adjusting circuit 230 to adjust a current sensing voltage V_{CS}. After the current sensing voltage V_{CS} is adjusted, for example, to become higher (note that the adjustment is substantially proportional to the adjusted input current), the comparing circuit 240 compares the adjusted current sensing voltage V_{CS}′ with a predetermined over-current protection reference voltage to selectively enable the over-current protection mechanism based on the comparison result. For example, if the adjusted current sensing voltage V_{CS}′ reaches the predetermined over-current protection reference voltage, the over-current protection mechanism is enabled. Therefore, the over-current protection circuit 200 can respond before the over-current situation actually occurs, and even after a time delay for the over-current protection mechanism to take effect, the current sensing voltage has not yet exceeded the over-current protection reference voltage. Hence, the damage induced by the over-current can be prevented.

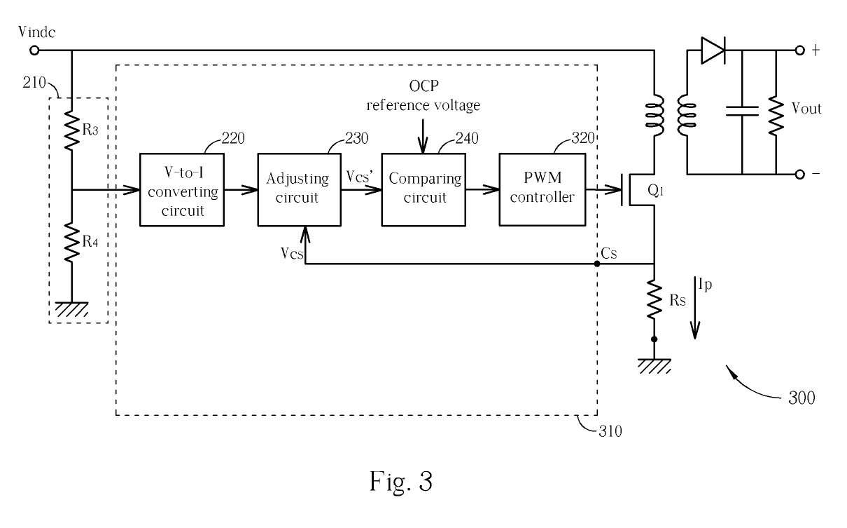

When the over-current protection circuit 200 is implemented in an electrical device such as a voltage converter, the over-current protection circuit 200 can effectively protect the electrical device from suffering from an over-current. FIG. 3 is a diagram showing how the over-current protection circuit 200 is implemented in a fly-back converter 300 according to an exemplary embodiment of the present invention. Note that the elements in FIG. 3 have the same functions as those with corresponding numbers in FIG. 2. In this embodiment, the voltage divider 210 is composed of the resistors R₃ and R₄, while the voltage-to-current converting circuit 220, the adjusting circuit 230, and the comparing circuit 240 are built inside an integrated circuit (IC) 310. This is for illustrative purposes only, however, and not intended as a limitation of the scope of this invention.

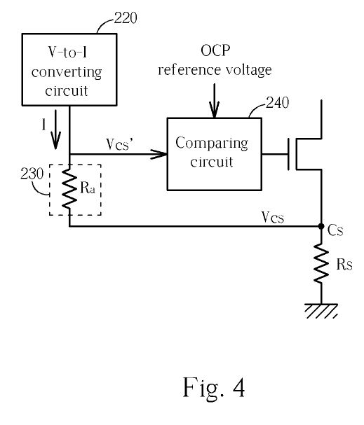

In this embodiment, the input DC voltage V_{indc} is a ripple DC voltage generated from rectifying an input AC voltage of the voltage converter 300 by a well-known bridge rectifier (not shown). The voltage divider 210 divides the input DC voltage V_{indc} to generate an adjusted input voltage and then inputs the adjusted input voltage into the IC 310. The voltage-to-current converting circuit 220 converts the adjusted input voltage into an adjusted input current. The adjusting circuit 230 then adjusts a current sensing voltage V_{CS} by adding a voltage corresponding to the adjusted input current to the current sensing voltage V_{CS} (note that the current sensing voltage V_{CS} is a voltage generated at a terminal of the current sensing resistor R_{S} when the primary current I_{P} of the voltage converter 300 flows through the current sensing resistor R_{S}, that is, V_{CS}=I_{P}*R_{S}). FIG. 4 shows an exemplary embodiment of the aforementioned adjusting circuit 230. As shown in FIG. 4, the adjusting circuit 230 is a resistance element, implemented by a resistor Rₐ having a first end coupled to the voltage-to-current converting circuit 220 and the comparing circuit 240 and a second end coupled to the CS pin in this embodiment. In this way, the adjusted input current I flows through resistors Rₐ and R_{S}, making the voltage level at the first end of the resistor Rₐ equal to the current sensing voltage V_{CS} added by I*Rₐ. Therefore, the voltage input to the comparing circuit 240 is the adjusted current sensing voltage V_{CS}′. The resistance of Rₐ is usually much larger than the resistance of R_{S}; for example, the resistance of Rₐ can be 10-20 KΩ, and the resistance of R_{S} is 1-3Ω. A large Rₐ can reduce current I, therefore minimizing the influence of current I on other circuit components in the converter 300 and lowering the power consumption.

Please note that FIG. 4 is only for illustrative purposes and is not meant to be a limitation of the present invention. In other embodiments, the resistance element may be implemented by a plurality of resistors, at least one Metal-Oxide-Semiconductor Field-Effect Transistors (MOSFETs), at least one Bipolar Junction Transistors (BJTs), or combinations thereof. Since a skilled person can readily appreciate these alternative designs of the adjusting circuit 230 after reading the above disclosure, further description is omitted here for the sake of brevity.

To determine whether the over-current protection mechanism should be enabled, the comparing circuit 240 compares the adjusted current sensing voltage V_{CS}′ with a predetermined over-current protection reference voltage. If the adjusted current sensing voltage V_{CS}′ reaches the predetermined over-current protection reference voltage, the comparing circuit 240 will output a control signal to a PWM controller 320. Then the PWM controller 320 will keep a PWM signal at logic low. Therefore the transistor Q₁ is turned off. Since the adjusted input current is proportional to the input DC voltage V_{indc}, the adjustment of the current sensing voltage is also proportional to the input DC voltage V_{indc}, and the disclosed over-current protection circuit can therefore solve the above-mentioned delay problem properly regardless of how high the input voltage is.

Moreover, since R₃ and R₄ are not coupled to the transistor Q₁ or the current sensing pin CS, they can be designed to have high resistance values in order to lower their power consumption, and doing so will not adversely affect the time delay or influence the detection abilities of the IC 310.

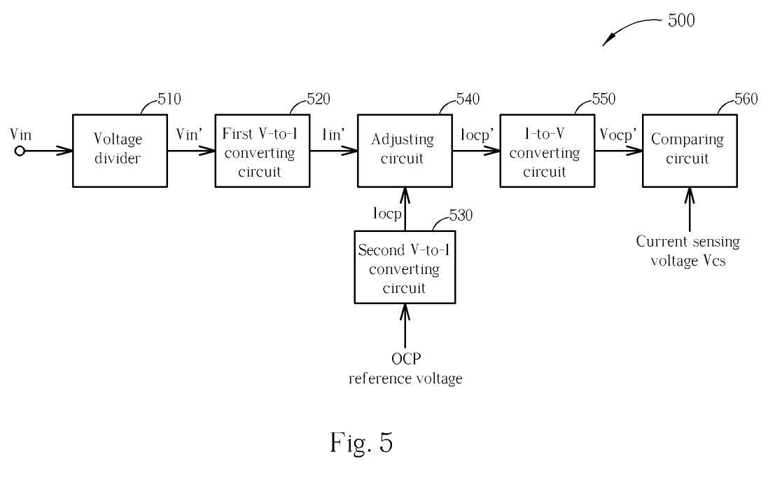

FIG. 5 is a diagram of an adjustable over-current protection circuit 500 according to another exemplary embodiment of the present invention. Differing from the over-current protection circuit 200 of FIG. 2, the over-current protection circuit 500 adjusts a predetermined over-current protection reference current according to an adjusted input current and utilizes the adjusted over-current protection reference current as a reference to determine whether the over-current protection mechanism should be enabled. Therefore, the over-current protection circuit 500 comprises a voltage divider 510, a first voltage-to-current converting circuit 520, a second voltage-to-current converting circuit 530, an adjusting circuit 540, a current-to-voltage converting circuit 550, and a comparing circuit 560. The voltage divider 510 is for dividing an input voltage Vᵢₙ to generate an adjusted input voltage Vᵢₙ′, wherein the adjusted input voltage Vᵢₙ′ is then converted into an adjusted input current Iᵢₙ′ by the following first voltage-to-current converting circuit 520. The second voltage-to-current converting circuit 530 is for converting a predetermined over-current protection reference voltage OCP into an over-current protection reference current I_{OCP}. The adjusted input current Iᵢₙ′ generated by the first voltage-to-current converting circuit 520 and the over-current protection reference current I_{OCP} generated by the second voltage-to-current converting circuit 530 are both fed into the adjusting circuit 540, which adjusts the over-current protection reference current I_{OCP} to become lower according to the adjusted input current Iᵢₙ′ to generate an adjusted over-current protection reference current I_{OCP}′ (note that the adjustment is substantially proportional to the adjusted input current Iᵢₙ′). The adjusted over-current protection reference current I_{OCP}′ is then converted into an adjusted over-current protection reference voltage V_{OCP}′ by the current-to-voltage converting circuit 550. The comparing circuit 560 compares the adjusted over-current protection reference voltage V_{OCP}′ with a current sensing voltage V_{CS} to selectively enable an over-current protection mechanism according to the comparison result.

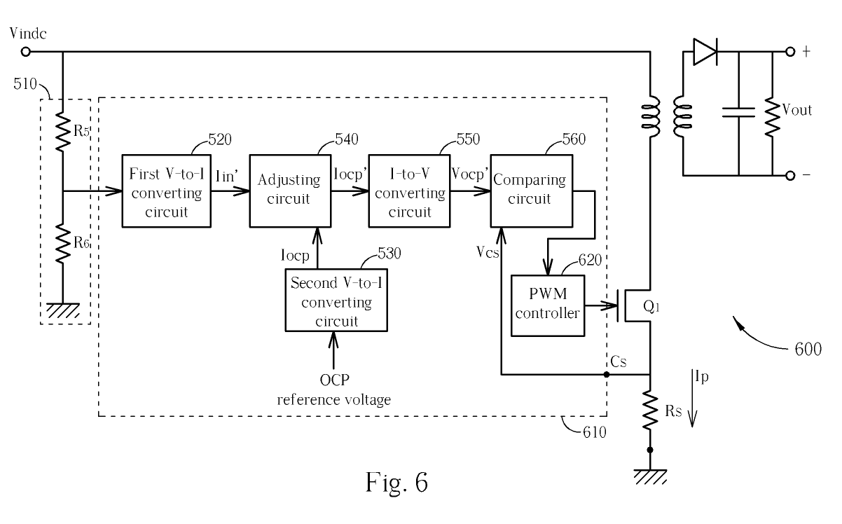

As can be seen from the above description, the over-current protection circuit 500 can adjust the over-current protection reference voltage in order to enable the over-current protection mechanism prior to the over-current occurrence, thereby solving the aforementioned delay problems. FIG. 6 is a diagram showing how the over-current protection circuit 500 is implemented in a voltage converter according to an exemplary embodiment of the present invention. The elements in FIG. 6 have the same function as those with corresponding numbers in FIG. 5. In this embodiment, the voltage divider 510 is composed of the resistors R₅ and R₆, and the first voltage-to-current converting circuit 520, the second voltage-to-current converting circuit 530, the adjusting circuit 540, the current-to-voltage converting circuit 550 and the comparing circuit 560 are built inside an integrated circuit (IC) 610. This is for illustrative purposes only, however, and is not intended to be a limitation of the scope of this invention.

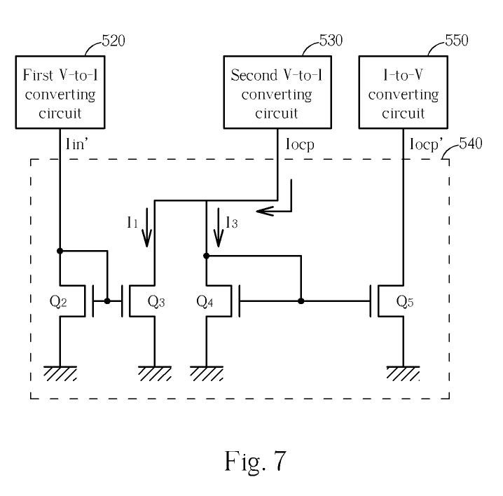

In this embodiment, the input DC voltage V_{indc} is a ripple DC voltage generated from rectifying an input AC voltage of the converter 600 by a bridge rectifier (not shown). The voltage divider 510 divides the input DC voltage V_{indc} to generate an adjusted input voltage and inputs the adjusted input voltage into the IC 610. Then the first voltage-to-current converting circuit 520 converts the adjusted input voltage into an adjusted input current Iᵢₙ′. The second voltage-to-current converting circuit 530 converts a predetermined over-current protection reference voltage into an over-current protection reference current I_{OCP}. The adjusting circuit 540 then adjusts the over-current protection reference current I_{OCP} by subtracting the adjusted input current Iᵢₙ′ from the over-current protection reference current I_{OCP}. An exemplary embodiment of the adjusting circuit 540 having the above-mentioned function is illustrated in FIG. 7. As shown in FIG. 7, the adjusting circuit 540 can be implemented by a plurality of MOSFETs forming a plurality of current mirrors. In this embodiment, the transistors Q₂ and Q₃ are substantially identical to each other and form a current mirror, and the adjusted input current Iᵢₙ′ generated by the first voltage-to-current converting circuit 520 induces a current I₁ equal to the adjusted input current Iᵢₙ′ flowing through Q₃. According to Kirchhoff's junction rule, the sum of the currents entering a junction must equal the sum of the currents leaving that junction. That is, the current flowing through Q₄ (i.e. I₃) must be equal to the over-current protection reference current I_{OCP}′ subtracted by the adjusted input current I₁. Since the transistors Q₄ and Q₅ are substantially identical to each other and form another current mirror, the current input to the current-to-voltage converting circuit 550 (i.e. I_{OCP}′) is equal to I₃, thereby achieving the function of the adjusting circuit 540 mentioned above (I_{OCP}′=I_{OCP}−Iᵢₙ′).

After the adjusted over-current protection reference current I_{OCP}′ is converted into an adjusted over-current protection reference voltage V_{OCP}′ by the current-to-voltage converting circuit 550, the comparing circuit 560 compares the adjusted over-current protection reference voltage V_{OCP}′ with the current sensing voltage V_{CS} to determine whether the over-current protection mechanism needs to be enabled. If the current sensing voltage V_{CS} reaches the adjusted over-current protection reference voltage V_{OCP}′, the comparing circuit 560 will output a control signal to a PWM controller 620. Then the PWM controller 620 will keep a PWM signal at logic low. Therefore the transistor Q₁ is turned off. This will in turn shut down the current flowing through the converter 600 to protect the voltage converter 600 from suffering from damage caused by the over-current.

Similar to FIG. 3, the resistors R₅ and R₆ are not coupled to the transistor Q₁ or the noise-sensitive current sensing pin CS so that the resistance values of R₅ and R₆ can be high enough to reduce power consumption without adversely affecting the delay or the detection efficiency of the IC 610.

To conclude, the over-current protection circuits 200 and 500 both advance the trigger timing of the over-current protection mechanism to compensate for the above-mentioned problems resulting from the delayed response of the over-current protection circuit and the RC time constant of a resistor-capacitor circuit. Furthermore, the timing advancements correspond to the input voltage: the over-current protection mechanism is triggered in advance such that it takes effect before the current sensing voltage is larger than the predetermined over-current protection reference voltage. In this manner, the over-current situation can be properly prevented in time, regardless of the input voltage. The major difference between the over-current protection circuits 200 and 500 is that the over-current protection circuit 200 adjusts the current sensing voltage while the over-current protection circuit 500 adjusts the predetermined over-current protection reference voltage. The power consumption of both circuits, however, is low since the resistance values in the voltage dividers 210 and 510 are specifically designed to be large. Moreover, the over-current protection circuits 200 and 500 may be combined together to simultaneously adjust both the current sensing voltage and the predetermined over-current protection reference voltage when detecting the over-current situation. It should be noted that the implementations of the over-current protection circuits 200 and 500 are not necessarily limited to voltage converter applications; any electronic device in need of over-current protection can also adopt the disclosed over-current protection circuits of the present invention.

Those skilled in the art will readily observe that numerous modifications and alterations of the device and method may be made while retaining the teachings of the invention.

What is claimed is:

1. An adjustable over current protection circuit, comprising:
a voltage divider, for dividing an input voltage to generate an adjusted input voltage;
a voltage-to-current converting circuit, coupled to the voltage divider, for converting the adjusted input voltage into an adjusted input current;
an adjusting circuit, coupled to the voltage-to-current converting circuit, for adjusting a current sensing voltage generated by a current flowing through a current sensing resistor according to the adjusted input current to generate an adjusted current sensing voltage; and
a comparing circuit, coupled to the adjusting circuit, for comparing the adjusted current sensing voltage with a predetermined over current protection reference voltage to selectively enable an over current protection mechanism according to a comparison result.

2. The adjustable over current protection circuit of claim 1, being implemented in a fly-back converter, wherein the input voltage is an output of a rectifier circuit of the voltage converter, and the adjusting circuit is coupled to a current sensing resistor of the voltage converter to adjust the current sensing voltage generated by a primary current of the voltage converter flowing through the current sensing resistor.

3. The adjustable over current protection circuit of claim 1, wherein the adjusting circuit generates the adjusted current sensing voltage by adding the current sensing voltage to a voltage corresponding to the adjusted input current.

4. The adjustable over current protection circuit of claim 1, wherein the adjusting circuit is a resistance element, a first end of which is coupled to the voltage-to-current converting circuit and the comparing circuit, and a second end of which is coupled to the current sensing resistor.

5. The adjustable over current protection circuit of claim 4, wherein the resistance element comprises at least one resistor.

6. The adjustable over current protection circuit of claim 4, wherein the resistance element comprises at least one Metal-Oxide-Semiconductor Field-Effect Transistor (MOSFET).

7. The adjustable over current protection circuit of claim 4, wherein the resistance element comprises at least one Bipolar Junction Transistor (BJT).

8. The adjustable over current protection circuit of claim 4, wherein the resistance element comprises at least one resistor and at least one transistor.

9. The adjustable over current protection circuit of claim 1, wherein the voltage-to-current converting circuit, the adjusting circuit and the comparing circuit are implemented inside an integrated circuit (IC).

10. An adjustable over current protection circuit, comprising:
a voltage divider, for dividing an input voltage to generate an adjusted input voltage;
a first voltage-to-current converting circuit, coupled to the voltage divider, for converting the adjusted input voltage into an adjusted input current;
a second voltage-to-current converting circuit, for converting a predetermined over current protection reference voltage into an over current protection reference current;
an adjusting circuit, coupled to the first and second voltage-to-current converting circuits, for adjusting the over current protection reference current according to the adjusted input current to generate an adjusted over current protection reference current;
a current-to-voltage converting circuit, coupled to the adjusting circuit, for converting the adjusted over current protection reference current into an adjusted over current protection reference voltage; and
a comparing circuit, coupled to the current-to-voltage converting circuit, for comparing the adjusted over current protection reference voltage with a current sensing voltage generated by a current flowing through a current sensing resistor to selectively enable an over current protection mechanism according to a comparison result.

11. The adjustable over current protection circuit of claim 10, being implemented in a fly-back converter, wherein the input voltage is an output of a rectifier circuit of the voltage converter, and the comparing circuit is coupled to a current sensing resistor of the voltage converter for receiving the current sensing voltage generated by a primary current of the voltage converter flowing through the current sensing resistor.

12. The adjustable over current protection circuit of claim 10, wherein the adjusting circuit generates the adjusted over current protection reference current by subtracting the adjusted input current from the over current protection reference current.

13. The adjustable over current protection circuit of claim 10, wherein the adjusting circuit comprises:
a first transistor having a control end, a first end and a second end, wherein the control end is coupled to the first end, the first end is coupled to the first voltage-to-current converting circuit, and the second end is coupled to a voltage level;
a second transistor, having a control end, a first end and a second end, wherein the control end is coupled to the control end of the first transistor, the first end is coupled to the second voltage-to-current converting circuit, and the second end is coupled to a voltage level;
a third transistor, having a control end, a first end and a second end, wherein the control end is coupled to the first end, the first end is coupled to the second voltage-to-current converting circuit, and the second end is coupled to a voltage level; and
a fourth transistor, having a control end, a first end and a second end, wherein the control end is coupled to the control end of the third transistor, the first end is coupled to the current-to-voltage converting circuit, and the second end is coupled to a voltage level.

14. The adjustable over current protection circuit of claim 10, wherein the first and second voltage-to-current converting circuits, the adjusting circuit, the current-to-voltage converting circuit and the comparing circuit are implemented inside an integrated circuit (IC).
